(19) United States
(12) Patent Application Publication
(10) Pub. No.: US 2002/0143975 A1
(43) Pub. Date: Oct. 3, 2002

(54) Media distribution systems and multi-media conversion server

(76) Inventors: Junichi Kimura, Koganei (JP); Yoshinori Suzuki, Saitama (JP); Kenji Nagamatsu, Kokubunji (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/942,615

(22) Filed: Aug. 31, 2001

(30) Foreign Application Priority Data
Apr. 2, 2001 (JP) 2001-102922

(51) Int. Cl. G06F 15/16

(52) U.S. Cl. 709/231; 709/237

(57) ABSTRACT

An object of the present invention is to realize a multi-media communication terminal wherein power consumption is reduced and necessary transmission capacity between terminals is reduced at an economical cost.

A distribution system transmits and receives media information via a server that relays a multi-media communication data between a transmission terminal and a receiving terminal, wherein video information is stored in a speech and video synthesis server attached to a distribution server in advance, and at the time of a communication, converted into output video information in accordance with media decoding capability of a receiving terminal based on already stored video information, thereby transmitting the output video information to the receiving terminal.

### BACKGROUND OF THE INVENTION

This invention in general relates to a media distribution system and a multi-media conversion server, and more specifically to a hand-held multi-media terminal or a mobile multimedia terminal to be used for a communication system which transmits and receives information containing video and speech/audio information, and to a multi-media server which relays communication data between the hand-held multi-media terminals.

Video signals (moving picture) and speech or audio signals can be transmitted after compressing such signals at the order of tens of kilo-bit per second (hereinafter referred to as “bps”) by using international standards such as ISO/IEC 14496 (MPEG-4). In addition, after compressing video and/or speech signals for a definite period of time by using the MPEG-4 format, the encoded data thus obtained can be transmitted in one file or separated video and speech files along with electronic mail data (text information).

Transmission and reception of video and speech files by means of a conventional multi-media terminal are performed by transferring such files to a distribution server (for example a mail server) through a transmission line after being compressed by a transmission terminal. The distribution server transfers a mail to a corresponding receiving terminal to which such received data are addressed. Alternatively, the distribution server monitors the connection of the receiving terminal to the distribution server, and when the connection is verified, transfers information of a mail arrival at the receiving terminal, or transfers the mail itself to the receiving terminal.

To the transmission terminal stated above are inputted character information to be transmitted (for example, key-down event information), video signals and speech signals, and the character information is decoded by an editing device into character codes, which are then stored in a memory as text information. The video signals are compressed into video stream and are then stored in the memory. The speech signals are compressed into speech stream and are then stored in the memory. Following an instruction by a user of a transmission terminal, the transmission terminal calls a distribution server to establish a transmission channel. Thereafter, the text information (including mail addresses and body texts of mails) stored in the memory, video stream and speech stream are read out to be transmitted to the server via the established transmission channel.

Regarding transmission information on the transmission channel, destinations, text information, speech information and video information are transmitted in a fixed format. The distribution server which received data from a transmission terminal (hereinafter referred to as “mail data”) stores such input information in a buffer. At this time, a charge system control records the transmission, which is used for charging a fee, in accordance with the information amount received by the distribution server, to a transmitter. Thereafter, the server decodes a destination of a mail from mail data stored in the buffer, and calls a receiving terminal corresponding to the destination. Upon the establishment of a transmission line between the distribution server and the receiving terminal, the server reads out mail information (including text information, speech information and video information) stored in the buffer, and transmits such information to the receiving terminal as mail data.

Upon having a call from the distribution server, the receiving terminal establishes a transmission channel between the distribution server and the receiving terminal, and stores mail information transmitted by the distribution server in a memory. A user of the receiving terminal selects the mail information received, applies a text display processing to display the information on a display device, and reads the information. Further, the user reads out video streams or speech codes as required to decode video or speech signals.

In addition, with the multi-media distribution system stated above, it is necessary to mount a picture inputting camera and a video encoder to create a video stream, which in turn not only increases terminal cost but requires additional power consumption resulting in a shorter service life of a battery to drive the transmission terminal. Therefore, there is caused a problem to impair portability due to the enlarged size of the terminal as a result of the incorporation of a battery with larger capacity, and further there is caused an another problem wherein the number of terminals which are capable to communicate each other is small due to the necessity to support the same video compression algorithm. To solve the problem, as described in Japanese Patent Laid-open No. 6-162167, there has been known, as an example of an another prior art, a method wherein voices or pictures are synthesized at the receiving terminal in accordance with received character information, and parameters being used during the synthesis process are designated by the transmission terminal.

In the another prior art, the information processing amount and the transmission capacity of a transmission terminal and a distribution server can be reduced, while, on the contrary, considerations have not been given to a point wherein substantial processing capabilities are required to achieve synthesizing processes at the receiving terminal, causing a cost overrun as well as requiring additional power, resulting in a shorter service life of a battery to drive the transmission terminal, which in turn impairs the portability due to the enlarged size of the terminal as a result of the incorporation of a battery with larger capacity. In addition, considerations have not been given to a point wherein the maintenance serviceability and the expandability of synthesizing algorithms become insufficient, since the transmission terminal should learn parameters of the synthesizing algorithms of the receiving terminal in advance.

### SUMMARY OF THE INVENTION

Accordingly, a first object of the present invention is to realize a multi-media distribution system which enables media distribution between a transmission terminal and a receiving terminal even in case the same media information compression algorithm is different, and a server used for the multi-media distribution server.

Another object of the present invention is, in addition to the achievement of a first object, to realize a multi-media distribution server which is capable of reducing the data processing amount of both a transmission terminal and a receiving terminal as well as reducing in the power consumption and operating costs thereof.

In order to achieve the objects stated above, the present invention provides a distribution system which transmits and receives media information (text, video and speech information) via a server that relays multi-media communication data between a transmission and a receiving terminals, wherein the server comprises means for acquiring media decoding capability of the receiving terminal and means for converting media information from the transmission terminal to be output into media information according to the media decoding capability thus acquired. Hereinafter, the server with the configuration will be called a multi-media conversion server.

For the purpose described above, a multi-media conversion server according to the present invention comprises: receiving means for receiving media information transmitted from a first terminal (transmission terminal); means for acquiring a destination of the media information received; means for acquiring a media decoding capability of a second terminal (receiving terminal) which is the address stated above; conversion means for converting the media information to media information to be output according to the media decoding capability; and output means for transmitting the media information to the receiving terminal.

A preferred embodiment according to the present invention provides a multi-media conversion server, wherein media information received by the receiving means is character information; and the media decoding capability is of format information; the conversion means including means for converting the character information into a speech signal, means for synthesizing a video signal according to the synthesized speech, means for encoding the synthesized speech signal by using a format which allows a second terminal to receive and decode, and means for encoding the synthesized video signal by using a format which allows a second terminal to receive and decode; the output means including means for adding the synthesized speech streams and the synthesized video streams to the character information, and transmitting such information to the receiving terminal.

In the present invention, a transmission terminal can execute communication without awareness of media decoding algorithms of a receiving terminal. In addition, the processing amount at the transmission terminal and the receiving terminal can be reduced, by synthesizing and creating speech and video information based on text information, thus realizing miniaturization of a personal digital assistant (PDA) and expansion of service life of a terminal battery.

The foregoing and other features as well as advantages of the present invention will be stated in further details by referring to preferred embodiments of the invention described in the following. It should be noted that, in the following description, information corresponding to each sound of a speech shall be called speech segment information, a series of information wherein speech segments are combined shall be called speech information, each screen configuring moving pictures shall be called an picture or a frame, and a series of information wherein pictures and frames are combined shall be called a video information.

### BRIEF DESCRIPTION OF THE DRAWINGS

FIG. 1 is a configuration block diagram showing a first preferred embodiment of a multi-media distribution system according to the present invention;

FIG. 2 is a flow chart showing procedures to acquire information of speech and video decoding capability 2102;

FIG. 3 is a drawing showing an example of an information management of speech and video decoding capability in a terminal database server 107 in FIG. 1;

FIG. 4 is a drawing showing an example of a terminal capability transmission format and information of speech and video decoding capability to be sent back to a distribution server;

FIG. 5 is a process flow chart for a speech capability of information of speech and video decoding capability at a distribution server 101 in FIG. 1;

FIG. 6 is a process flow chart for a selection method wherein a priority is set for an algorithm selection in FIG. 5;

FIG. 7 is a configuration diagram of a multi-media terminal to be used for a distribution system according to the present invention;

FIG. 8 is a configuration diagram of a transmission terminal 100 wherein only a transmission function of a multi-media terminal 1000 in FIG. 7 is picked out;

FIG. 9 is a diagram showing a signal to be transmitted in a transmission channel 2 in FIG. 8;

FIG. 10 is a screen view for a speech and video selection in a synthesized speech and synthesized video selection unit 110 in FIG. 8;

FIG. 11 is a configuration diagram of a preferred embodiment of a distribution server according to the present invention;

FIG. 12 is a configuration diagram of a preferred embodiment of a speech and video synthesis server according to the present invention;

FIG. 13 is an explanatory diagram of a speech and video synthesis in FIG. 12;

FIG. 14 is an explanatory diagram of a speech and video synthesis in FIG. 12;

FIG. 15 is a configuration diagram of a second preferred embodiment of a multi-media distribution system according to the present invention;

FIG. 16 is a configuration diagram of a preferred embodiment of a receiving terminal 150 in FIG. 15;

FIG. 17 is a configuration diagram of a third preferred embodiment of a multi-media distribution system according to the present invention;

FIG. 18 is a pattern diagram of a transmission data in FIG. 17;

FIG. 19 is a configuration diagram of a transmission terminal 200 in FIG. 17;

FIG. 20 is a configuration diagram of a distribution server 201 in FIG. 17;

FIG. 21 is a configuration diagram of a speech and video synthesis server 204 in FIG. 17;

FIG. 22 is a configuration diagram of a fourth embodiment of a multi-media distribution system according to the present invention;

FIG. 23 is a configuration diagram of a receiving terminal 250 in FIG. 22;

FIG. 24 is a configuration diagram of a sixth embodiment of a multi-media distribution system according to the present invention;

FIG. 25 is a configuration diagram of a distribution server 2200 in FIG. 24; and

FIG. 26 is a configuration diagram of a video conversion server 2202 in FIG. 25.

### DETAILED DESCRIPTION OF THE PREFERRED EMBODIMENTS

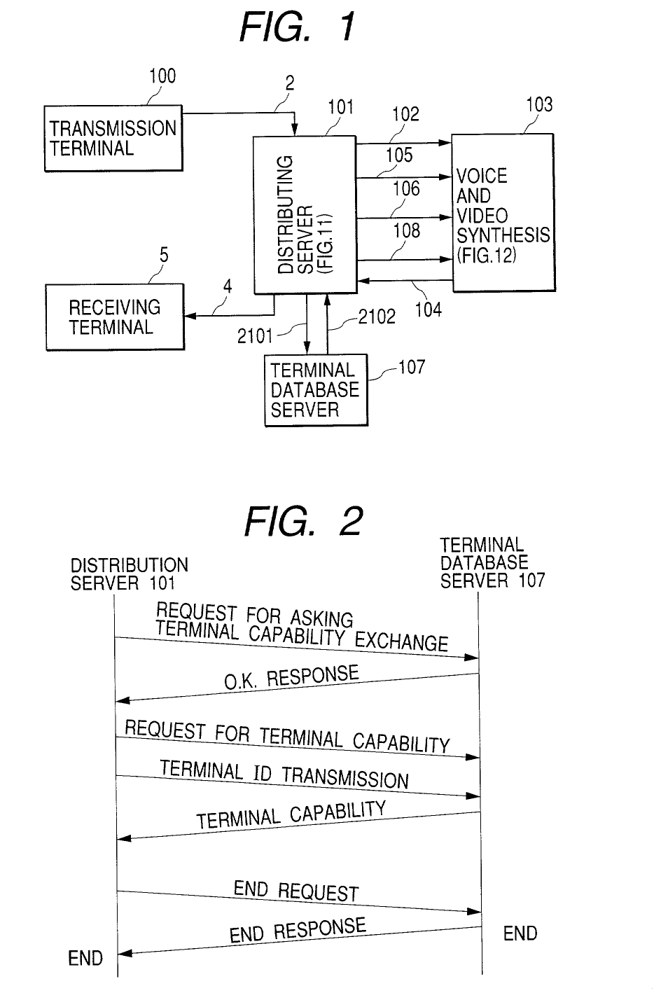

FIG. 1 is a configuration block diagram showing a first preferred embodiment of a multi-media distribution system according to the present invention. The preferred embodiment enables a multi-media terminal to transmit and receive video and speech files, and also enables a transmission terminal to transmit information without awareness processing capability of a receiving terminal.

The present system refers to a multi-media distribution system which has a server to distribute media information transmitted from a transmission terminal 100 to a receiving terminal 5, where the distribution system comprises: means for acquiring media decoding capabilities of the receiving terminal 5 using a terminal database server 107; and a speech and video synthesis server 103 for converting the media information into media information to be output according to the media decoding capabilities thus acquired.

The transmission terminal 100 transmits, to the distribution server 101 via a transmission channel 2, discrimination information 2101 (terminal ID) of a receiving terminal, text information, and a selection signal which selects respective one of predetermined pictures and speeches. The distribution server 101 sends a request for processing capabilities of the receiving terminal 5 to a terminal database server 107, by the notifying discrimination information 2101 of the receiving terminal 5.

The terminal database server 107 notifies the distribution server 101 of speech and video decoding capability 2102 including a speech format, a video format and a screen size which is visible and audible for the receiving terminal 5, and the distribution server 101 determines speech and video encoding algorithm based on the information of speech and video decoding capability 2102. The distribution server 101 transmits received test information 102, picture selection signal 106, speech selection signal 105 and the speech and video encoding algorithm 108 to the speech and video synthesis server 103.

The speech and video synthesis server 103, based on the text information 102, synthesizes and encodes speech signal and video signal according to contents described in the text, and returns a speech and video stream 104 thus obtained to the distribution server 101. The distribution server 101 transmits, via a transmission channel 4, text information transmitted from the transmission terminal 100 and the speech and video stream 104 obtained from a speech and video synthesis server to the receiving terminal 5. The receiving terminal 5 decodes received signal, and displays and decodes the text information, the video signal and the speech signal respectively.

FIG. 2 is a flow diagram showing a procedure to acquire the information of speech and video decoding capability 2102 in FIG. 1. The distribution server 101 sends a signal of a request for asking a terminal capability exchange and a request for a terminal capability to the terminal database server 107. Discrimination information of terminal (terminal ID) such as a mail address, a telephone number, an equipment number and an equipment model number. The distribution server 101, upon receiving an acceptance response identifying the signal of a request for asking a terminal capability exchange 2102, transmits the terminal ID, while the terminal database server 107 returns corresponding information of speech and video decoding capability 2102. The distribution server 101, upon receiving the information of speech and video decoding capability 2102, notifies an end response and completes a receiving process of the information of speech and video decoding capability.

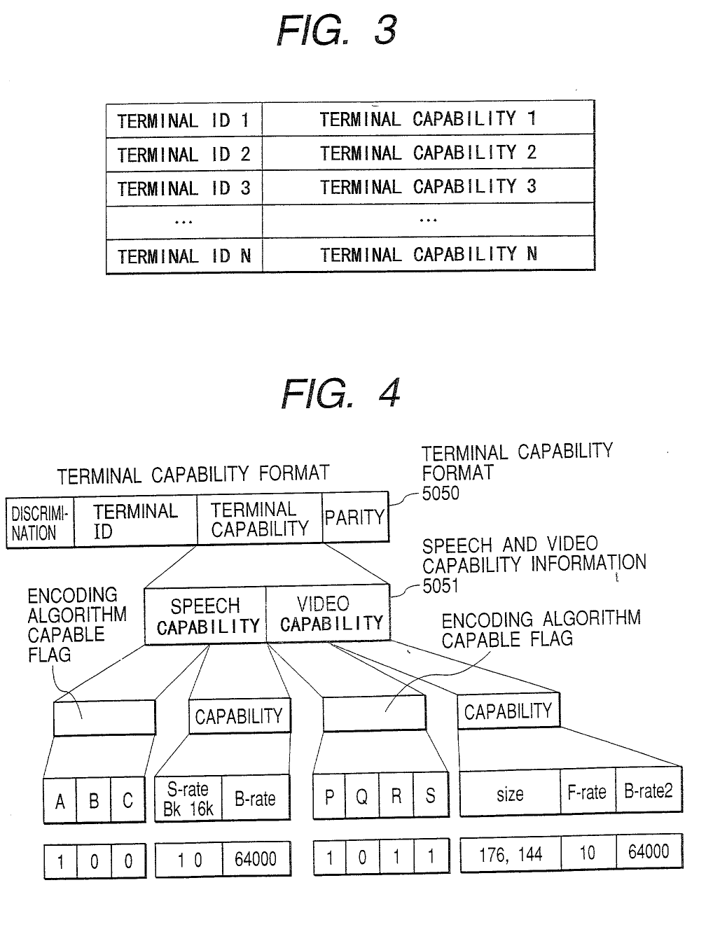

FIG. 3 shows an example of information management of speech and video decoding capability to be executed in the terminal database server 107. The terminal database server 107 is provided with a table wherein a terminal ID shown in FIG. 3 and information of speech and video decoding capability corresponding to the ID are combined into a set. When the terminal database server 107 receives a request for acquiring information of speech and video decoding capability from the distribution server 101, the server retrieves the table illustrated in FIG. 3 using the terminal ID which is notified along with the request, and returns the information of speech and video decoding capability 2102 obtained through the retrieval.

FIG. 4 shows a terminal capability transmission format and information of speech and video decoding capability (terminal capability) which are to be returned to the distribution server 101. The terminal capability transmission format 5050 is configured with four fields comprising; a discrimination field, a terminal ID field, a terminal capability field and a parity field. The discrimination field is a code indicating that terminal capability will be transmitted in subsequent data thereof. The terminal ID field returns the terminal ID that is requested by the distribution server 101. The distribution server 101 verifies the validity of data received, by comparing information of the terminal ID field with the terminal ID thus requested. The terminal capability field is, as shown in an outgoing channel in FIG. 4, data (information of speech and video decoding capability 5051) indicating a terminal capability respectively with regard to speech and video image. The parity field is information to verify that there is no transmission error, for example, in data (bits and bytes) of the discrimination field, the terminal ID field and the terminal capability field, and such items including parities and CRC codes fall into parity field. Further, in addition to the above, a mechanism to allow a receiving side to modify a transmission error, if it is a minor one, may be provided by using error correction codes (including, for example, a Reed-Solomon code or a BCH code).

Details of information of speech and video decoding capability 5051 is shown in the lower part of FIG. 4. Speech capability information and video capability information respectively comprise an encoding algorithm capable flag and a capability. The encoding algorithm capable flag provides a flag respectively to, for example, a plurality of encoding algorithms and options that can be a candidate, and if respective encoding algorithms are supported, the flag sets TRUE, and if not, the flag sets FALSE. In FIG. 4, three candidates of encoding algorithm A, B and C are available for a speech encoding algorithm, and four candidates of encoding algorithm P, Q, R and S for a video encoding algorithm. An example in the figure shows that a support is given only to an encoding algorithm A for speech, and to other encoding algorithms except Q for video (1=TRUE). The capability indicates a numeric limit that is subordinate to an encoding algorithm shown in an encoding algorithm capable flag and a capability, which includes, for example, a bit rate (shown as “B-rate” and “B-rate 2” in the figure), a speech sampling rate used in a speech processing (shown as “S-rate” in the figure), a maximum picture size used in a video processing (shown as “size” in the figure), and a frame rate (shown as “F-rate” in the figure). The capability includes one that is expressed in numeric values such as the bit rate and the frame rate, one that shows values indicating TRUE or FALSE for predetermined numeric values like the sampling rate, and one that is expressed in combinations of a plurality of scalar values like picture size. In addition, other methods are available including a method to encode the above-stated capability, and a method to select values from among a plurality of predetermined “ranges of values.” It may also be possible to make an extension, while retaining a compatibility in the future case of increasing the number of encoding algorithms, by providing an “extension flag” along with both the encoding algorithm capable flag and the capability, and thus achieving a structure to allow the addition of a new field if the extension flag is true. Further, besides the capability of speech and video, capabilities of texts, graphics, communication systems and high-quality audio, for example, can be described in a similar description method.

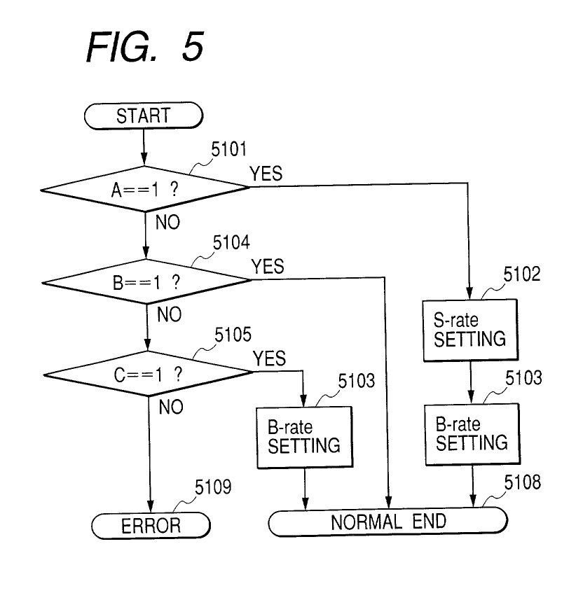

FIG. 5 is a flow chart for processing a speech capability of information of speech and video encoding capability 5051 in the distribution server 101. The distribution sever 101, while decoding the received information of speech and video encoding capability 5051, first judges, a judgment unit 5101, whether an encoding algorithm A is supported or not, or if a flag is 1. If the encoding algorithm A is supported, the sever acquires and sets a related capability value, that is a sampling rate 5102 or a bit rate 5103, from data, and performs a normal end. If the encoding algorithm A is not supported, the server 101 checks an encoding algorithm B, and if the encoding algorithm B is not supported, the server checks an encoding algorithm C. If either one of the encoding algorithms is supported, the server 101 acquires a related capability and performs a normal end.

In FIG. 5, it is assumed that, in an encoding algorithm B, a capability need not be acquired since a sampling rate and a bit rate are constant, and in the encoding algorithm C, a capability should be acquired since only a bit rate is variable (For an encoding algorithm A, either of a sampling rate or a bit rate is assumed to be selectable). If neither of the encoding algorithms A, B or C is supported, which is then regarded as an error, and information that no corresponding encoding algorithm is available is notified of the transmission terminal 100. It should be noted that, in the above-stated description, a judgment on algorithm encoding is made in the fixed priority of A, B and C, but the judgment may set to be variable, or may set to be variable depending on an operating status of hardware.

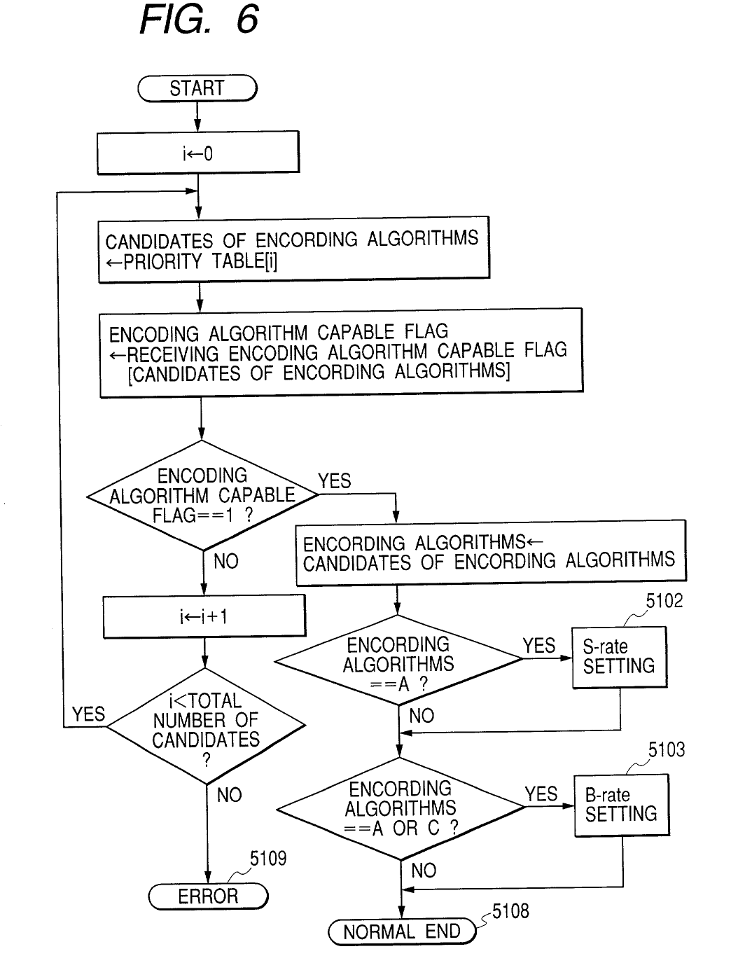

FIG. 6 is a process flow chart for a selection method wherein a priority is given to the algorithm encoding stated above. In the figure, first of all, information to discriminate an encoding algorithm (a code assigned them encoding algorithm, for example) is described in sequence: Priority Table [i], starting with a number of 0 in the order i of desired encoding algorithm. At this time, the number of all encoding algorithm candidates shall be “the number of candidates.” First, using a parameter i, “candidates of encoding algorithm” are selected in the order of encoding algorithms listed in the priority table [i]. Also, the candidates are selected from among Sequence: receiving algorithm [ ] which has received the “encoding algorithms capable flag” corresponding to the encoding algorithm of “candidates of encoding algorithm.” Then, a check is made to see whether the “encoding algorithms capable flag” is 1 (true) or 0 (not), and if the flag is 1 (true), the “candidates of encoding algorithm” is adopted as the “encoding algorithms capable flag”, thereafter, an adequate capability for the encoding algorithm is set, and the normal end is executed. On the other hand, if the “encoding algorithms capable flag” is 0 (false), a comparison is made with “the number of candidates” after increasing the parameter i in steps, and if any candidates remain yet, the step to select the “candidates of encoding algorithm” is resumed. Then, an examination is made on an encoding algorithm with the next priority. During the comparison process of the parameter i and “the number of candidates”, if an examination of “the number of candidates” pieces of candidates covering from 0, which implies that i is equivalent to “the number of candidates”, to “the number of candidates −1” has been completed, then the case is regarded that no corresponding candidate is available, and an error end is executed.

In the method of FIG. 6, the priority may be changed at any time before starting each examination. Further, by not registering an encoding algorithm listed in the priority table, it is possible not to select the encoding algorithm even if a terminal supports the algorithm (a flag corresponding to a receiving algorithm flag [ ] is true)

FIG. 7 is a configuration diagram of a multi-media terminal 1000 which corresponds to the transmission terminal 100 and the receiving terminal 5 that are used for a distribution system according to the present invention. For the purpose of a simplification, descriptions will be made separately by referring to the terminal 100 from which only a transmission function is selected and also to the terminal 5 from which only a receiving function is selected.

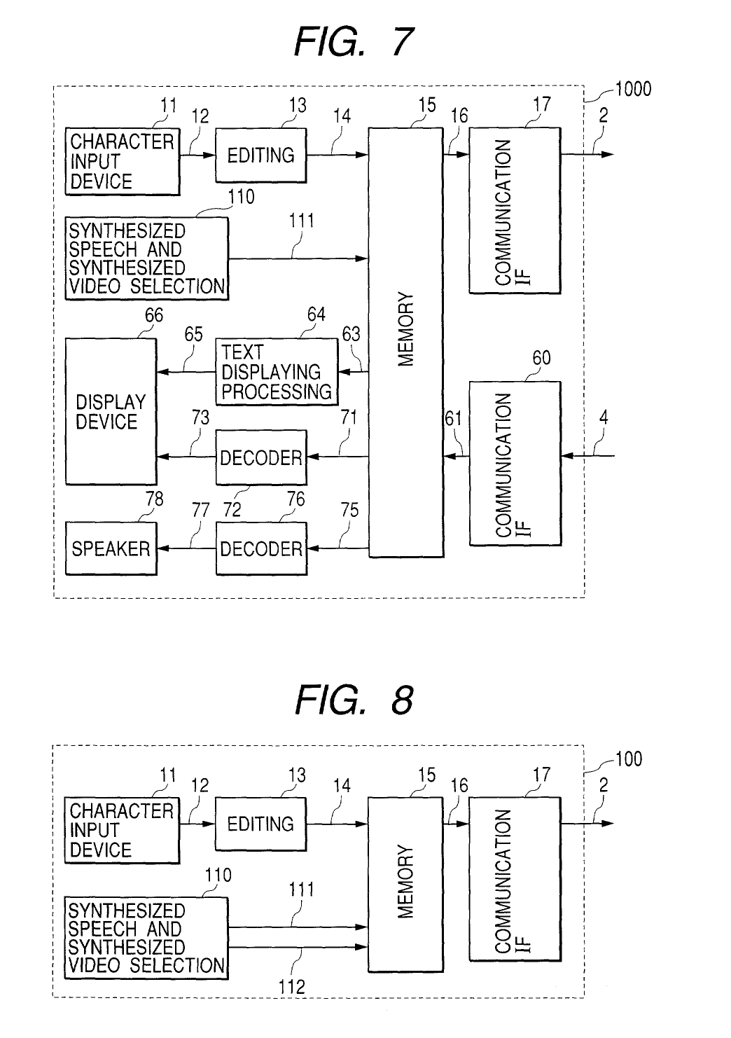

FIG. 8 is a configuration diagram of the transmission terminal 100, wherein only a transmission function of the multi-media terminal 1000 illustrated in FIG. 7 is selected. In the transmission terminal 100, character input information 12 which is supplied by an input device 11 is decoded by an editing device 13 to form a character code 14, and is stored in a memory 15 as a text information (destination information and text information, for example). Concurrently, a speech selection signal 111 and a video selection signal 112 are selected by a selector unit 110 which selects a type of a synthesized video signal and a synthesized speech signal to be supplied to a receiving side and are stored in the memory 15. When a transmission is executed, after having established the transmission channel 2 with the distribution server 101, the transmission terminal 100 transmits destination information 50, speech and video encoding information 115 and text information 51 to the distribution server 101, via a communication interface (IF) 17.

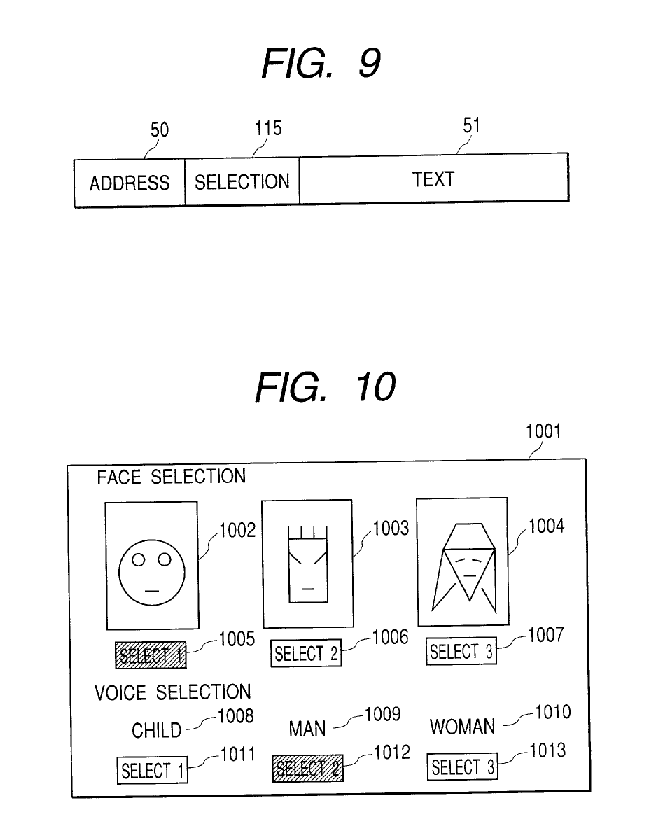

FIG. 10 shows examples of screen for speech and video selection in the synthesized speech and synthesized video selection unit 110. Information for a selection is displayed on a display device 66 of the multi-media terminal 1000, wherein data to be displayed has already been received, via the distribution server 101, from the speech and video synthesis server 103 and has already been stored in the memory 15. FIG. 10 shows a screen to select one face picture out of three face pictures 1002, 1003 and 1004, and to select one speech type out of three types of speeches 1008, 1009 and 1010, wherein the face pictures can be selected by using buttons 1005, 1006 and 1007 respectively, and the speech types can be selected by using buttons 1011, 1012 and 1013 buttons respectively. The figure illustrates a case where picture 1 (left) and speech 2 (center) have been selected. In this case, a signal indicating picture =1 and speech =2 is transmitted as a selection signal 115 in FIG. 9.

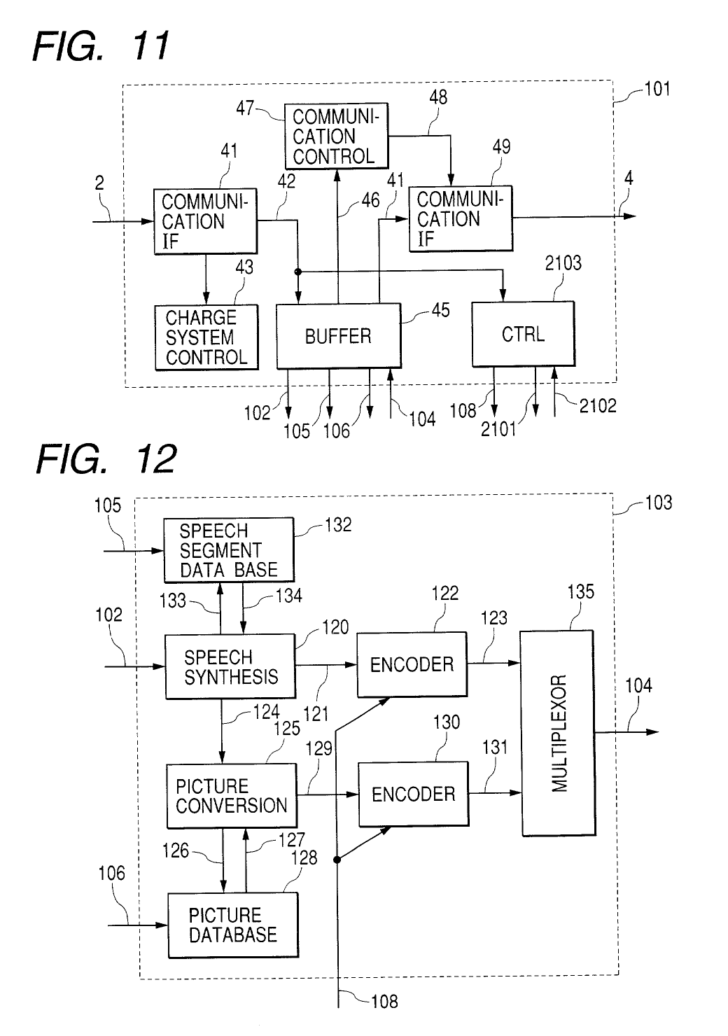

FIG. 11 is a configuration diagram for a preferred embodiment of a distribution server which configures a multi-media conversion server according to the present invention. The point that differentiates the distribution server 101 from conventionally-known distribution servers lies in an arrangement wherein signal lines 102, 105, 106 and 104 to establish communication with the speech and video synthesis server 103, and another signal lines 108, 2101 and 2102 to establish communication with the terminal database server 107 are added.

Operations of the distribution server 101 are configured with four phases. The first phase is to receive data (hereinafter referred to as “mail data”) from the transmission terminal 100, wherein information 42 that is supplied from the transmission channel 2 via a communication IF 41 is stored in a buffer 45. At this time, a charge system control 43 records, as required, information that is necessary for charging a fee to a transmitter, according to the amount of information received by the distribution server, use or disuse of a speech and picture synthesis function, and a fee according to a selection number for speech and picture synthesis. For example, when the speech and picture synthesis function is used, a fee (B) is charged which is higher than a fee (A) set for a case where the function is not used, and the balance (B-A) is spent for the management of the speech and picture synthesis server. In addition, if a specified picture is selected, a higher fee (C) is charged, wherein the balance (C-B) is handed over to a copyright holder of the picture thus used.

A second and a third phase can only exist in a case where a function to synthesize speech and picture is used. A judgment on whether the speech and picture synthesis function is used or not is made either by the fact if selection information 115 in FIG. 9 exists or not, or if contents of the selection information 115 show effective information, or by the fact if information to indicate “no selection” is available. It is also possible to set a rule in advance between a terminal and a server so that the second and the third phase can always be available. In addition, a notification can be executed by using an another signal.

In a second phase, a control unit 2103 of the distribution server 101 selects destination information 2100 from the received mail data, transmits discrimination information 2101 of a receiving terminal to the terminal database server 107, and acquires the information of speech and video decoding capability 2102 of the receiving terminal 5. A control unit 2103 determines a speech encoding algorithm and a video encoding algorithm corresponding to a decoding capability of the receiving terminal 5, and notifies the speech and video synthesis server 103 of the algorithms as a speech and video encoding algorithm 108.

In a third phase, the distribution server 101 transmits a duplicated copy of mail data received to the speech and video synthesis server 103 via the signal line 102. A code obtained as a result of a speech and video synthesis performed in the speech and video server 103 is received (by the distribution server 101) via the signal line 104 and is then stored in the buffer 45.

A fourth phase is initiated at an arbitrary time after the completion of a third phase (or a first phase if the third phase is not available). In the fourth phase, a communication control unit 47 reads out mail data 46 stored in the buffer, and decodes a destination of the mail data 46. Then, the unit 47 gives an instruction to a communication IF 49 to call a terminal corresponding to the destination, that is, a receiving terminal 5. At a time when a communication has been established between the transmission channel 4 and the receiving terminal 5, the unit 47 reads out text information of mail information stored in the buffer 45 as well as, if any, a speech and video synthesis code, and transmits the mail data to the receiving terminal 5 via the communication IF49 and the transmission channel 4.

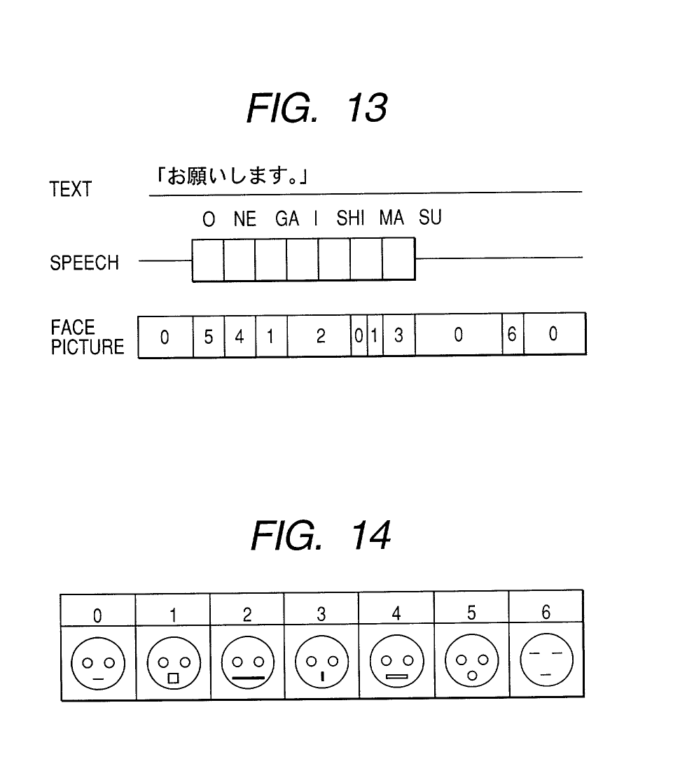

FIG. 12 is a configuration diagram for a preferred embodiment of the speech and video synthesis server 103 in FIG. 6. Before a description is made on operations in FIG. 12, a description will be made on a principle of a speech and video synthesis by referring to FIG. 13 and FIG. 14. In FIG. 13, if a text “Onegai Shimasu” is converted into a speech and a video image, the text is first analyzed before being converted into sound information “O NE GA I SHI MA SU”. At this time, duration and accent location of respective sounds, for example, are determined. By arranging speech waveform data in order corresponding to respective speech segments converted (for example, “o” and “NE”) a speech corresponding to the text thus entered is synthesized.

On the other hand, in a picture synthesis process, a picture corresponding to each type of a speech segment is prepared in advance, and a corresponding picture is displayed only for a duration of each speech segment. Regarding a type of a picture, seven frames are prepared, for example, as shown in FIG. 14, and a picture corresponding to a sound is displayed.

Frame 0 (the leftmost in FIG. 14)

Silence period as well as “bi”, “n”, “ma”-row, “ba”-row and first half of “pa”-row

Frame 1 Sounds in “a”-line (a, ka, sa, ta, na, ha, ma, ya, ra, wa, ga, za, da, ba, pa)

Frame 2 Sounds in “i”-line

Frame 3 Sounds in “u”-line

Frame 4 Sounds in “e”-line

Frame 5 Sounds in “o”-line

Frame 6 For blinking

Regarding the case of the sound information “O NE GA I SHI MA SU”, as shown in FIG. 13, a picture is displayed so that frame numbers can be shifted in the order of 5→4→1→2→2→0→1→3. For Silence period available before the initiation of a speech, after the completion of a speech, and during a speech, Frame 0 is displayed and an Frame 6 is inserted as appropriate (for example, at a rate of 0.1 seconds for every 2 seconds), thereby giving an image of blinking, which will provide a user with more natural impression.

Operations of the speech and video synthesis server 103 will now be described by referring to FIG. 12 again. First, speech segment data corresponding to each sound is stored in a speech segment database 132, from which waveform information 134 is uniquely taken out by giving a speech type 105 to be selected and sound data 133 as well as, if required, information including sound rows located before and after generated sound and accents. Also, in a picture database 128, a plurality of frames as shown in FIG. 14 are stored, and if a video type 106 to be selected and a selection frame number 126 to be obtained from sound information are given, a frame 127 can uniquely be obtained.

In a synthesis process, text information 102 is supplied to a speech conversion unit 120, where the text information 102 is converted into sounds, and a duration of sound data and each sound is determined. Sound data 133 thus converted is then supplied to the speech database 132, where speech waveform data 134 is output to the speech conversion unit 120 based on the speech selection signal 105 that is designated by the distribution server 101, and the sound data 133. The speech conversion unit 120 outputs the speech waveform data thus entered to a speech output waveform signal 121 only for the duration stated above. The waveform signal 121 thus output can be an actual sound (speech) if the signal is directly subjected to a digital-analog conversion, but in the speech and video synthesis server 103, the signal 121 is supplied to a speech encoder 122 as it is, and then compressed by an encoding algorithm indicated by a speech and video encoding algorithm 108 to obtain speech encoding data 123.

On the other hand, the speech conversion unit 120 supplies sound data and information on duration of the sound to a frame selection unit 125, where a frame number 126 to be displayed is determined based on sound information, and is then supplied to a picture database 128. The picture database 128 outputs display frame data 127 based on a picture selection signal 106 that is designated by a distribution server 101, and the frame number 126. The frame selection unit 125 retains the display frame data 127 that is supplied by the picture database 128, and outputs frame data 129 for specified duration in a manner to be synchronized with a corresponding speech signal 121. The frame data 129 can be viewed as a moving picture with a moving mouth when converting a display format and displaying it on a television set. For example, in the speech and video synthesis server 103, the frame data 129 is supplied, in a status of original digital signal, to a video encoder 130, and compressed under a video encoding algorithm as indicated by a speech and video encoding algorithm 108 to obtain video encoding data 131. A video encoding data 123 and the video encoding data 131 are multiplexed into one signal at a multiplexer 135 so that respective data can be synchronized, and are returned to the distribution server 101 as speech and video encoding data 104.

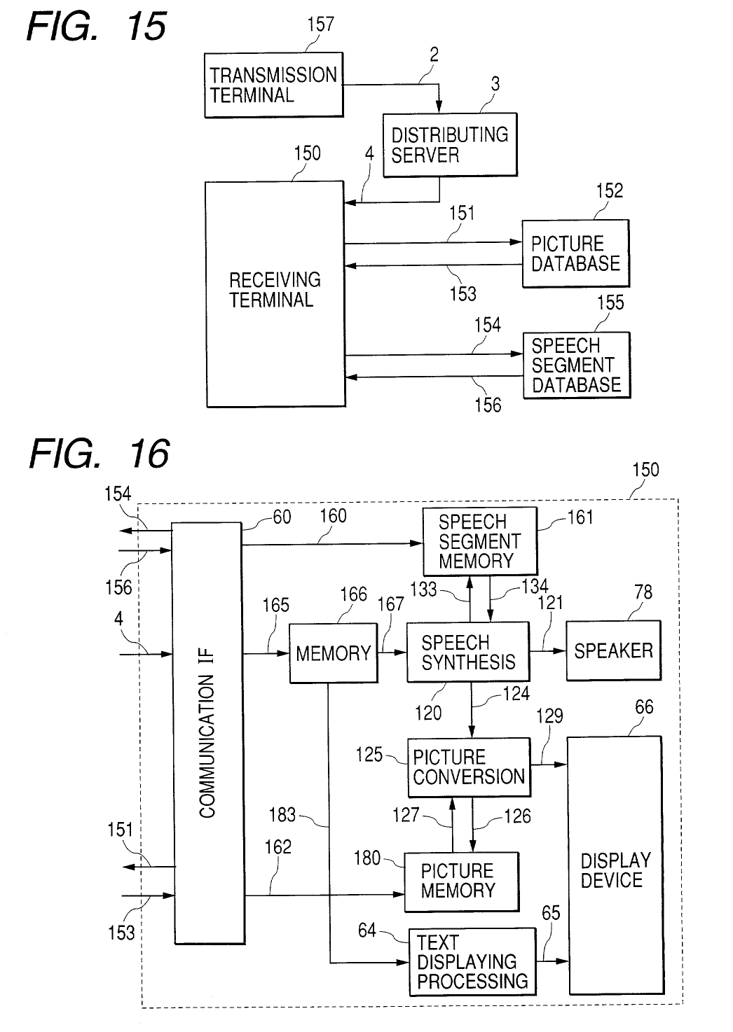

FIG. 15 is a configuration diagram for a second preferred embodiment of a multi-media distribution system according to the present invention.

The point which is different from a first preferred embodiment lies in an arrangement wherein a speech and video synthesis processing is performed in a receiving terminal, that is, a receiver should select a speech and a video image to be synthesized. A transmission terminal 157 employs almost the same configuration as that of a transmission terminal 100 illustrated in FIG. 8, but has no synthesized speech and synthesized video selection unit, that is, the terminal 157 is a terminal which transmits text information only. Text information thus transmitted reaches a receiving terminal 150 via a distribution server 3.

Before making an access to text information, a receiving terminal 150 is connected to a picture database server 152 and a speech segment database server 155, transmits desired picture selection signal 151 and speech selection signal 154 to the respective servers 152 and 155, and acquires corresponding frame data set 153 and speech segment set 156. The frame data set is a set of frame data comprising, for example, seven face pictures as illustrated in FIG. 14, and if a picture contained in the frame data set is selected and output in accordance with sound information, a picture synchronized with speech can be synthesized. On the other hand, a speech segment set is a set of waveform data of respective sounds to be used when a speech is synthesized according to a text. The receiving terminal 150 executes and outputs a speech and video synthesis by using text information 4 received and the frame data set 153 as well as the speech segment data set 156.

FIG. 16 is a configuration diagram for a preferred embodiment of the receiving terminal 150 in FIG. 15. Text information 4 received is stored in a memory 166 via a communication IF60. Before making an access to a mail, the receiving terminal 150 receives a frame data set 153 and a speech segment set 156 via the communication IF60, and stores the sets respectively in a picture memory 180 and a speech segment memory 161. A speech and video synthesis is performed according to an instruction of a user by using the text information 4, the frame data set 153 and the speech segment data set 156, wherein the processing is substantially the same as the processing illustrated in FIG. 12.

In other words, a speech conversion unit 120 and a video conversion unit 125 determine necessary data and make an access to the data. An access point for such data is a speech segment database 132 or a picture database 128 for a case of FIG. 12; however, in FIG. 16, only a speech segment data set that is designated by a speech selection signal 105 located in the speech segment database illustrated in FIG. 12 is stored in the speech segment memory 161. Likewise, only a frame data set that is designated by a picture selection signal 106 in the picture database 128 illustrated in FIG. 12 is stored in the picture memory 180. An example for the case of a picture will now be described hereunder:

Picture Database 128

| Selection Signal | Frame Data | | | | | | |
|---|---|---|---|---|---|---|---|
| 1 | CHILD0 | CHILD1 | CHILD2 | CHILD3 | CHILD4 | CHILD5 | CHILD6 |
| 2 | MAN0 | MAN1 | MAN2 | MAN3 | MAN4 | MAN5 | MAN6 |
| 3 | WOMAN0 | WOMAN1 | WOMAN2 | WOMAN3 | WOMAN4 | WOMAN5 | WOMAN6 |

Picture Memory 180

CHILD0 CHILD1 CHILD2 CHILD3 CHILD4 CHILD5 CHILD6

In the picture database 128, three types of frame data set are stored, which can be selected by the picture selection signal 106. For example, if selection signal=1, a frame data set comprising seven frames from CHILD0 to CHILD6 is used for a synthesis.

On the other hand, in the picture memory 180, a frame set comprising seven frames from CHILD0 to CHILD6 has already been downloaded from the picture database 152. For the downloading, if contents of the picture database 152 is the same as those of the picture database 129, 1 can be designated for a selection signal 151, for example.

As described above, a speech 121 and a video 129 that are synthesized in the same way as illustrated in FIG. 12 are output from a loudspeaker 78 and to a display device 66 respectively. Furthermore, depending on a selection by a user, text information that is received and stored in a memory 166 can be directly supplied to the display device 66 after having been converted into a character bitmap from character code data by a text display processing unit 64.

Text information can either be displayed in independent text information, by overlaying a character bitmap on video information, or by dividing a screen into two regions, thus allowing a display of video information in a region and a display of text information in another regions. In addition, to allow a display of the text information or not, or display mode stated above can be designated by a user.

In the second preferred embodiment of the multi-media distribution system according to the present invention, the system can be configured easily since a speech and video synthesis server becomes unnecessary and the distribution server 3 can be simplified to provide a function only to distribute texts and attached data. In addition, traffics to a receiving terminal from the distribution server become less in general when compared to those of a first embodiment, thus enabling communication with lower communication charges. On the other hand, the receiving terminal 150 has advantages as described in the following, since a speech and video synthesis function becomes necessary in the receiving terminal, which in turn makes the system size larger though.

More specifically, there is provided an advantage wherein a receiver can either choose to allow a selection of any picture and speech, or not to allow an output of a picture and a speech. In addition, a receiver can download a plurality of speech segment data sets and frame data sets, and specify how to manage a correlation between a candidate list of transmitters, and a speech and a picture downloaded in advance, thus allowing, regarding data sent by a specific transmitter, the specified speech and picture to be output. Further, if a data format for the speech segment data set and frame data set is used, each individual user can personally create a speech segment data set and a frame data set, and can perform speech and video synthesis by using such data created.

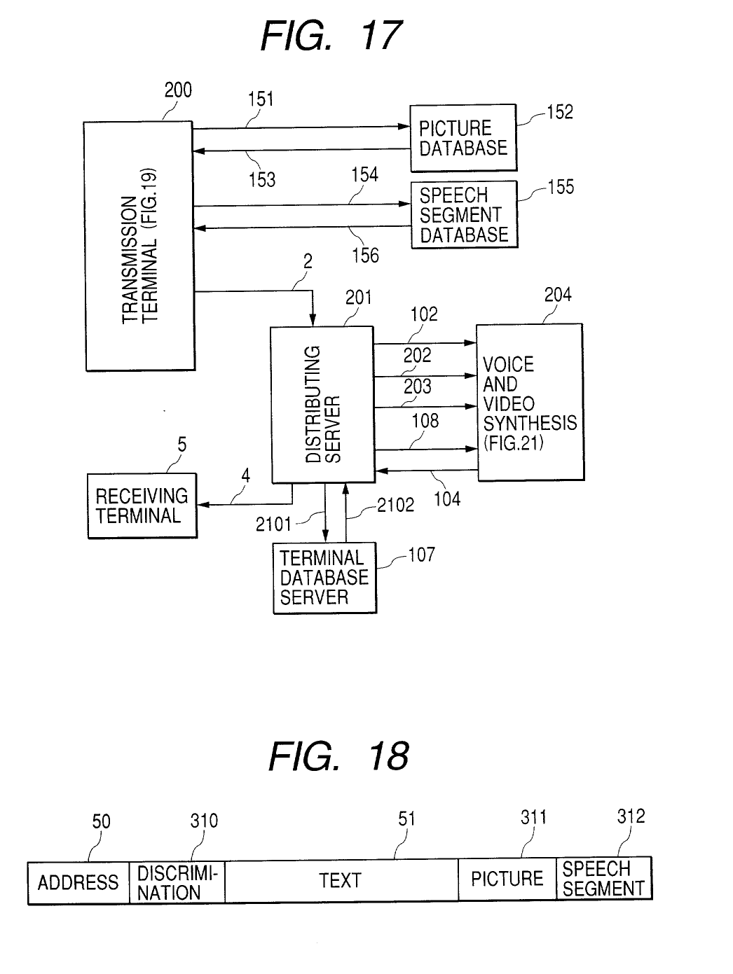

FIG. 17 shows a configuration diagram of a third preferred embodiment of a multi-media distribution system according to the present invention. The present embodiment realizes a service having the same functions as those described for a first preferred embodiment, and more specifically, a service wherein a type of a speech and a picture to be synthesized can be selected by a transmitter.

In FIG. 17, before a transmission terminal 200 transmits text information, a frame data set 153 and a speech segment data set 156 are downloaded in advance by establishing a connection to a picture database 152 and a speech segment database 155, and then by transmitting a picture selection signal 151 and a speech selection signal 154 respectively. At the time of the transmission of the text information, as shown in FIG. 18, a picture information 311 (frame data set) and speech segment information 312 that have been downloaded already are added to text information 51, and further, information with a discrimination code 310 which identifies that the picture information 311 and the speech information 312 have been added is transmitted.

A distribution server 201 and a speech and video synthesis server 204, after performing a speech and video synthesis by using text information, a frame data set and a speech segment data set that are transmitted from the transmission terminal 200, transmit text information and speech and video information to the receiving terminal 5 which is equivalent to a receiving terminal in FIG. 1.

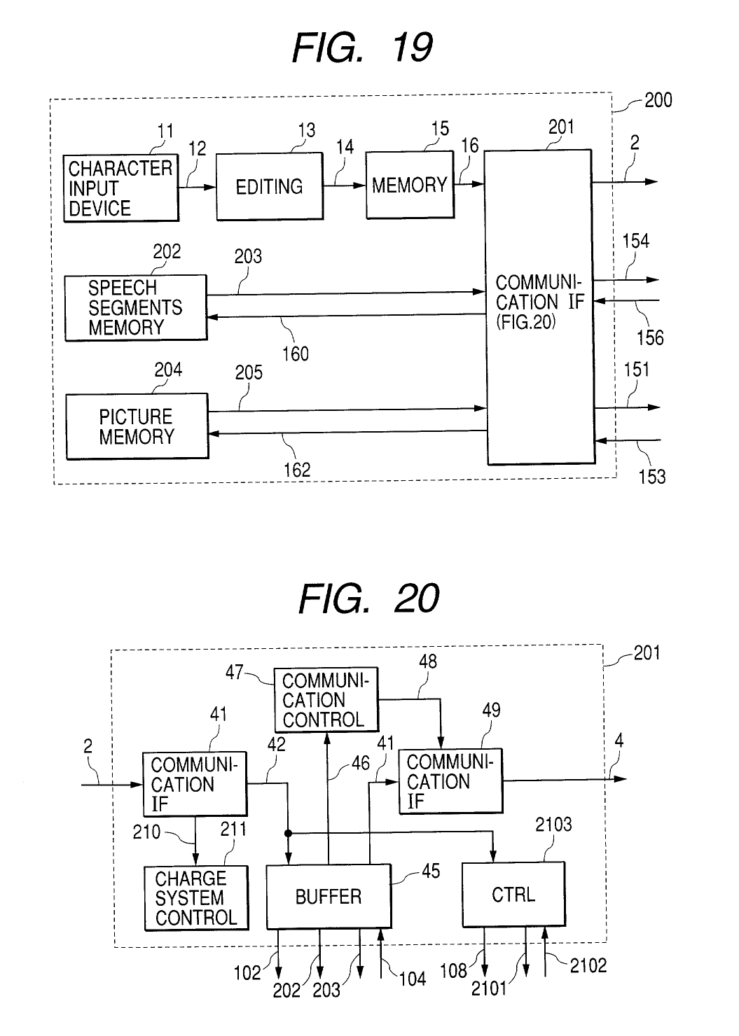

FIG. 19 is an example of a configuration of the transmission terminal 200 in FIG. 17. In the transmission terminal 200, a speech segment memory 202 and a picture memory 204 are arranged in place of a synthesized speech and synthesized video selection unit 110 in a transmission terminal 100 in FIG. 8.

A user stores text information 14 created by using a character input device 11 and an editing unit 13 in a memory 15. Before the text information 14 is transmitted, a speech segment data set 156 and a frame data set 153 are downloaded by using a communication IF 201, which are then stored in the speech segment memory 202 and the picture memory 204 respectively. The pieces of downloaded information are the same as data stored in a speech segment memory 161 and a picture memory 180 in FIG. 16. When the text information 16 is transmitted, the transmission terminal 200 outputs the text information 16, a speech segment data set 203 and a frame data set 205 to a transmission channel 2 via the communication IF 201.

FIG. 20 is a configuration diagram of the distribution server 201. The configuration and operations of the distribution server 201 are substantially the same as a configuration and operations of a distribution server 101 in FIG. 11, with a different point wherein, for the distribution server 101, a speech selection information 105 and a picture selection information 106 are transmitted as data to be supplied to the speech and video synthesis server 204, while for the distribution server 201, the speech segment data set 202 and the frame data set 203 are transmitted.

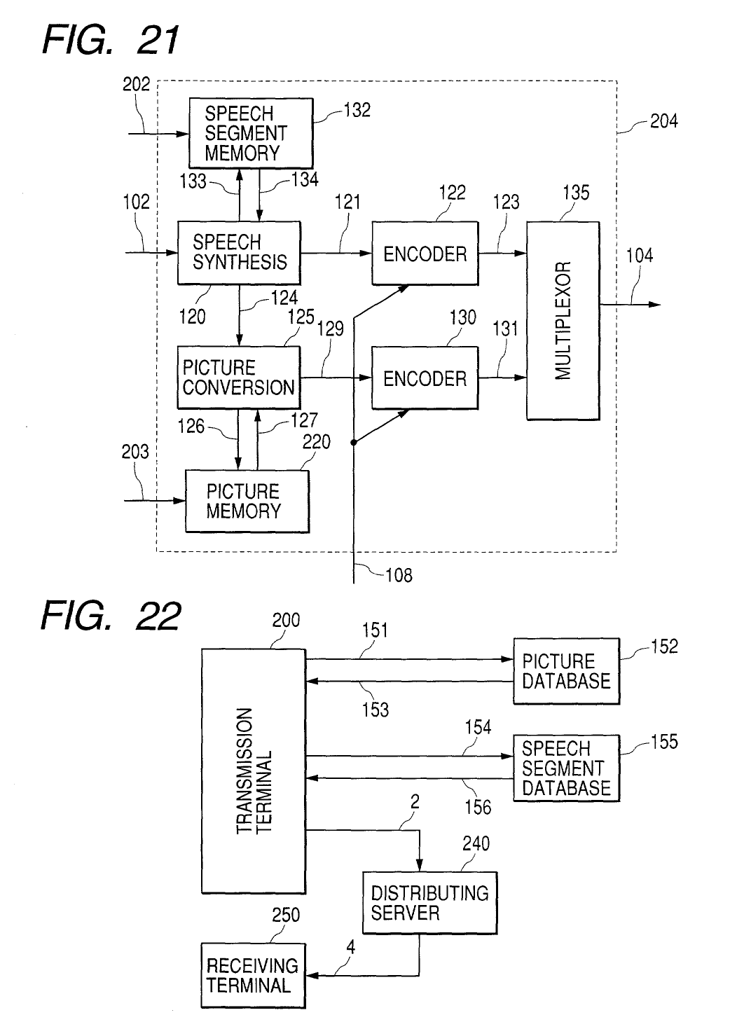

FIG. 21 is a configuration diagram of the speech and video synthesis server 204. The configuration and operations of the speech and video synthesis server 204 are substantially the same as a configuration and operations of a speech and video synthesis server 103 in FIG. 12, with a different point wherein, for the speech and video synthesis server 103, a speech selection signal 105 and a picture selection signal 106 are input, for which a speech segment data set and a frame data set to be used for a synthesis are selected respectively from a speech segment database 132 and a picture database 128, while for the speech and video synthesis server 204, the speech data set 202 and the frame data set 203 are input, each of which is stored in a speech segment memory 132 and a picture memory 220, and is then used for a synthesis.

An advantage of a third preferred embodiment is that a transmitter has a higher degree of flexibility in selecting speech and picture data. More specifically, with such an embodiment wherein a speech segment database and a picture database are incorporated in a speech and video synthesis server, selectable types of speech and picture, fees and so forth may be restricted by an operator of a speech and video synthesis server, while with the third preferred embodiment, it becomes possible that a speech and picture database server is operated by a plurality of persons other than an operator of a distribution server and an operator of a speech and video synthesis server, whereby, due to the market competition principle, the number of usable types of speech segment and picture increases and the use of data at an economical fee becomes feasible, thus offering increased advantages for users.

In addition, same speech and pictures can always be used by memorizing a speech segment data set and a frame data set that have been downloaded in advance in a transmission terminal. Further, by using a same data format, a personal speech and a picture of a user can be used, for example.

FIG. 22 is a configuration diagram of a fourth preferred embodiment of a multi-media distribution system according to the present invention, wherein a service having the same functions as those of the first and the third embodiments, more specifically, a service to select types of a speech and picture to be synthesized by a transmitter is realized.

A transmission terminal 200 is the same as the terminal of the third embodiment, and the data transmitted is the same as that of FIG. 18. A distribution server 240 is a so-called mail server which has only a function to transfer received data to a specified destination. Here, the point which differentiates the fourth embodiment from other embodiments is that data to be transmitted in a transmission channel 4 also has the same configuration as that shown in FIG. 18, more specifically, a configuration wherein a discrimination code 310, picture information 311 (frame data set) and speech segment information 312 are added to text information 51. A receiving terminal 250 performs a speech and video synthesis processing within the terminal by applying the discrimination code 310, and the picture information 311 (frame data set), and the speech segment information 312 to the text information 51 received.

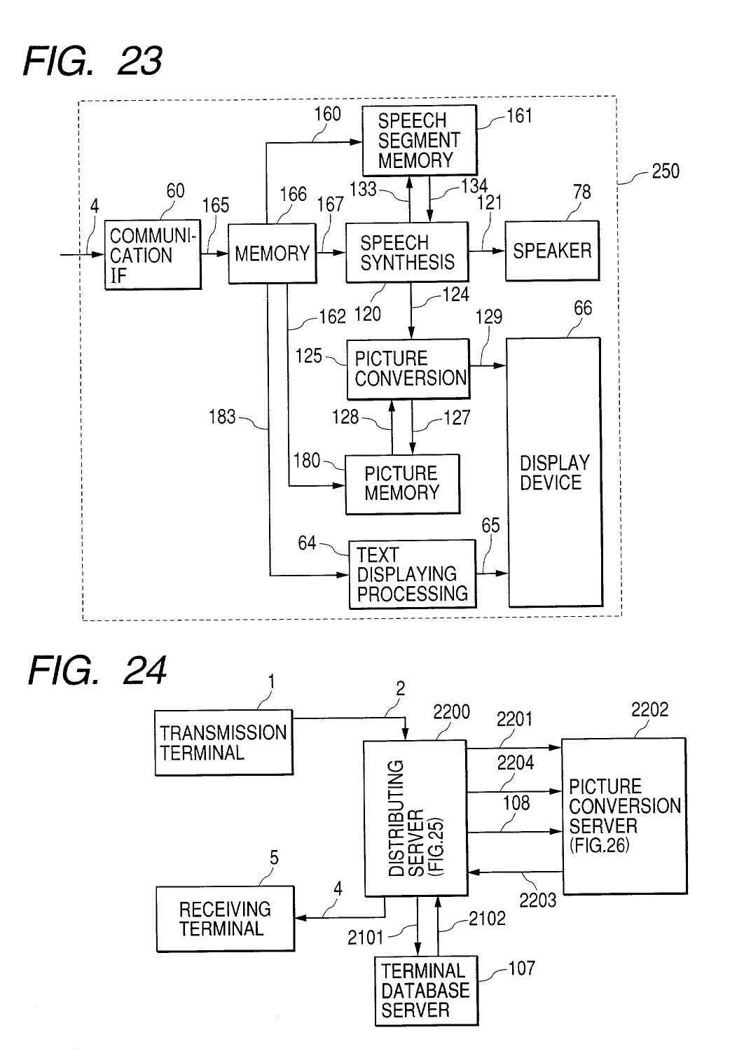

FIG. 23 is a configuration diagram of the receiving terminal 250 in FIG. 22. The structure and operations of the receiving terminal 250 are similar to those of a receiving terminal 150 in FIG. 16, with a different point wherein the receiving terminal 150 downloads a speech segment data set 160 and a frame data set 162 in advance respectively from different logic channels, while the receiving terminal 250, since the speech segment data set 160 and the frame data-set 162 have been added to receiving text data 165, selects the speech segment data set 160 and the frame data set 162 from a memory 166, and stores such data sets respectively to a speech segment memory 161 and a picture memory 180 after having stored the received data temporarily in the memory 166.

A fourth preferred embodiment has advantages wherein, as compared to a second preferred embodiment, a receiver need not download a speech segment and picture data in advance, and further while offering the same services as those of a first and a third embodiments, the volume of transmission data on a transmission channel 4 can be reduced.

Further, as a fifth preferred embodiment of a multi-media distribution system, the distribution system has a configuration, wherein text information to which a speech selection signal and a picture selection signal are added is received from a transmission terminal 100, a distribution server downloads a speech segment data set and a frame data set from a picture database 152 and a speech segment database 155 respectively, such speech segment data set and a frame data set are added to the text information received, and then the result is transmitted to a receiving terminal 250. With the fifth preferred embodiment, the traffic volume of an entire system can be minimized, while providing the same services as those of the first, the third and the fourth embodiments.

FIG. 24 is a configuration diagram of a sixth preferred embodiment of a multi-media distribution system according to the present invention. What differentiates the present preferred embodiment from the five embodiments is that a conversion processing is not based on a conversion from a text to a speech and a face picture but it is based on media information, more specifically, a conversion from a video stream to different system or to a video stream with different resolution (picture size). A transmission terminal 1, likewise a conventionally known transmission terminal, performs encoding of a taken picture within the terminal 1, attaches the encoded signal together with a speech and so forth to text information, and then the result is transmitted to a distribution server 2200 as a signal 2. A distribution server 2200 sends a request for capability exchange of a receiving terminal 5 to a terminal database server 107, and if an encoding algorithm of the signal 2 received is not available in decodable algorithms to which the request is made, the server 2200 sends a request to a video conversion server 2202 for conversion of a video encoding algorithm.

More specifically, a video-encoded part available in the signal 2 is selected, a video stream 2201 thus selected and the corresponding encoding algorithm 2204 thereof are output, and further, an algorithm 108 that is chosen either from an encoding algorithm which can be decoded by the receiving terminal 5 or from among common algorithms in encoding algorithms that can be processed by the video conversion server 2202, is notified. Here, the video encoding algorithm 2204 of the signal channel 2 can be clearly indicated in the signal 2 as, for example, a name of algorithm, or otherwise, can be indirectly indicated from, for example, a file attached with a picture.

In the video conversion server 2202, a video stream 2201 is converted into an algorithm that is indicated by the encoding algorithm 108 and is output as converted video stream 2203. The distribution server 2200 substitutes the converted video stream 2203 for a part corresponding to the original video stream (video stream 2201), and the result is then transmitted to the receiving terminal 5 as a signal 4.

FIG. 25 is a configuration diagram of a distribution server 2200 in FIG. 24. Basic configuration and operations are the same as those of a distribution server 101 in FIG. 11, with different points wherein an input signal 2 includes a video stream which should be a source of conversion, and the video stream 2201 and the video encoding algorithm 2204 are transmitted, in place of a speech and video synthesis server 103, to a video conversion server 2202 to acquire the converted video stream 2203. In addition, there is an another different point wherein, in order to acquire an encoding algorithm of the video stream 2201, received information 42 is inputted to a control unit 2103, in which the encoding algorithm is analyzed.

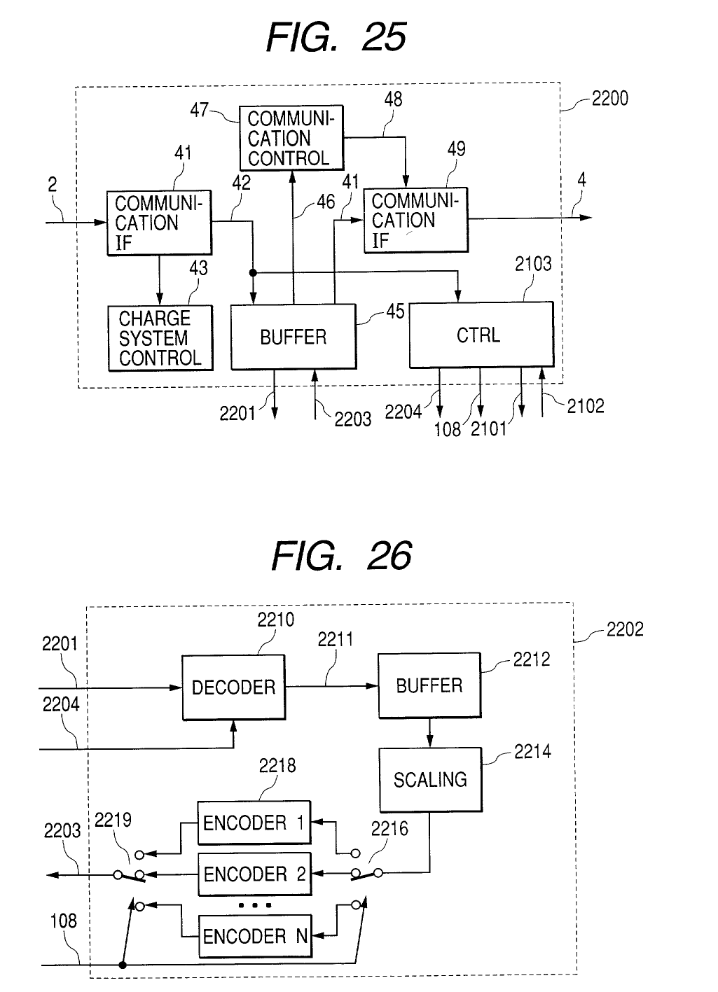

FIG. 26 is a configuration diagram of the video conversion server 2202 in FIG. 24. The inputted video stream 2201 is fed to a video decoder 2210. The video stream 2201 has a function to achieve a processing by switching a plurality of encoding algorithms and decode a video image in an algorithm indicated in the video encoding algorithm 2204. It should be noted that encoding algorithm information described in the video stream 2201 may be used in place of the video encoding algorithm 2204. A decoded video image 2211 is read out after having been stored in a buffer 2212, and is then supplied to a scaling unit 2214. In the scaling unit 2214, a conversion is made on, for example, a picture size, a frame rate, an interlace/progressive scanning algorithm and color sampling resolution. It should be noted that, if no change is made, for example, on picture size, the scaling unit can be bypassed. In addition, the scaling unit 2214 can be omitted in advance. A video image thus converted is supplied to a predetermined encoder 2218 that is selected by a switch 2216. The encoder 2218 is selected by the video encoding algorithm 108. A video stream thus encoded is output via a switch 2219 as the converted video stream 2203.

In a sixth preferred embodiment (FIG. 24 through FIG. 26), a conversion example from a video image (moving picture), as media information, to a different algorithm and to a video image with different resolution is shown.

Other word, in the sixth preferred embodiment, distribution server 2200, terminal database server 107 and video conversion server 2202 forms a multi-media conversion server. The multi-media conversion server has means 41 for receiving video information addressed to a second terminal 5 from a first terminal 1; means (107,22103,2201,2203 for receiving video information addressed to a second terminal 5 from a first terminal 1; means for acquiring video format (or screen size) information that can be received and decoded by said second terminal; means (included in 2103) for comparing the video format (or screen size) of said received video information with a video format (or screen size) that can be received and decoded by said second terminal 5; if any corresponding video format (or screen size) which allows the second terminal 5 to receive and decode the received video information is not available as a result of said comparison, means for selecting one video format (or screen size) that can be received and decoded by said second terminal 5, and converting said entered video information (or screen size) into that of the video format (or screen size) thus selected; and means for transmitting said converted video information to said second terminal 5.

Further ,the conversion can also be performed into the following: to a video image with different resolution and the same algorithm; to a video image with the same resolution and different algorithm; to a video image with different bit rate; and from a video image to part of frame of a video image (still image).

Further, as media information, a speech and an audio signal can be converted into a signal with a different algorithm, a different sampling rate, a different bandwidth and a different bit rate, by employing a similar configuration.

By combining unconverted media information (input media information) with converted media information (output media information), different conversion fees can be charged to a transmitter or a receiver, some examples of which are described in the following. An item positioned to the left of a [→] mark implies input media information, an item at the right side implies output media information, and a text following the [:] mark implies a charging system.

### EXAMPLE 1

High-resolution moving picture→Low-resolution moving picture: ¥10 per moving picture for 1 second

### EXAMPLE 2

Moving picture→A plurality of still images: ¥1 per still image

### EXAMPLE 3

Encoded speech signal→Speech signal encoded in different algorithm: ¥100 per use irrespective of the number of seconds

### EXAMPLE 4

Test information→Encoded speech+Moving face image: ¥100 for basic conversion fee+¥1 per character of text information

### EXAMPLE 5

Moving picture with speech→Moving picture with different speech: ¥100 per conversion of resolution, ¥20 per conversion of frame rate, ¥30 per conversion of bit rate, and ¥100 per conversion of speech encoding algorithm

The example 1 stated above can be realized, for example, by counting the number of seconds every time the scaling unit 2214 in FIG. 26 functions and by calculating a fee in accordance with the number of seconds thus calculated. In the example 2 and the example 3, a fee can be calculated respectively by counting the number of encodes, or the number of output images of a still image and by counting the number of startups of a speech code conversion processing. The example 4 can be realized by charging a basic fee at the time of starting a series of conversion processing, and thereafter by adding an additional fee on the basic fee every time a conversion of one character is made. In the example 5, a charging fee may be added on in accordance with an active/non-active status of each conversion unit, or a charge can be made by calculating an appropriate fee at the time of an analysis of a command which requests such processing. It should be noted that such calculations of a fee may be made for a charge in the distribution server 2201, or otherwise, may be made in the video conversion server 2202, and the calculation result may be notified of the distribution server 2201 for a charge.

Regarding a charging system, among the above-stated charging systems, wherein a fee depends on an algorithm of media to which a conversion is made, it can be set so that a charging of a conversion fee and an execution of a conversion operation are achieved only if a fee is calculated, the fee thus calculated is presented to a transmission terminal, and the transmission terminal verifies the fee and issues an acceptance instruction at the time when a media decoding capability of a receiving terminal is known.

For a case where a plurality of candidates are available depending on an encoding algorithm of a media to which a conversion is made, a description was made on a method, in a preceding embodiment, wherein a conversion server determines only one candidate in accordance with a predetermined priority. However, for a case where fees are different among a plurality of candidates, such a plurality of candidates and corresponding conversion fees may be notified of a transmission terminal for selection. It should be noted that the present invention includes, for example, a modification wherein, if a selection instruction is not available for a certain period of time, a candidates that is determined in a predetermined procedure is automatically selected and executed by a server, a method wherein a transmission terminal determines and set a procedure to select a candidate in advance, and a method wherein a transmission terminal gives an instruction for a suggested candidate or a procedure to select a candidate along with a transmission of media information. In addition, procedures to select a candidate include, for example, a method to instruct a candidate with the lowest fee, a method to indicate limits of converted parameters (including resolution, frame rate, and bit rate) and randomly select a candidate that is involved within the limits, and a method to indicate desired values for converted parameters and select a candidate showing the closest performance to such values.

In the above, descriptions have been made on preferred embodiments according to the present invention, which is, however, not limited to the preferred embodiments. Accordingly, for example, the following embodiments are intended to be embraced in the prevent invention.

In a first embodiment through a fifth embodiment, speech segment (half-wave) data of a speech segment data set and a picture data of a frame data set can be transmitted in an encoded form by using an encoding method of, for example, MPEG-4, wherein a reduction in traffic volume of an entire system and a reduction in a communication fee of a user can be expected since a transmission data volume becomes less.

In a first embodiment through a fifth embodiment, it was assumed that, upon a transmission of a text, a speech and a video image are output corresponding to contents of the text. However, such output may be only of a speech or of a video image. For a service to be provided by a distribution server, if a service only with a speech or only with a video image is provided, such devices including a processing unit and a server for a service not to be provided become unnecessary.

In a first embodiment through a sixth embodiment, charging is performed in a distribution server for data to be transmitted, but such charging may be made in accordance with data volume, or otherwise may be made in accordance with a duration of a connection between a transmission terminal and a distribution server. Further, a communication between a distribution server and a receiving terminal can be made based on either a charging in accordance with data volume or a charging in accordance with the duration of connection time between the receiving terminal and the distribution server. In addition, it is possible to charge a fee for communication between the receiving terminal and the distribution server to a transmission terminal. Also, it is possible to make charging by adding on an additional fee depending on the availability of a speech synthesis or of a video synthesis.

It should be noted that a description has been made on a procedure for respective preferred embodiments on the assumption that data is automatically transmitted from a distribution server to a receiving terminal, but the other procedure wherein a connection to a distribution server is established by a receiving terminal to send a request to the server for the availability of data addressed to the receiving terminal, and if appropriate data is available, the data is transmitted into the receiving terminal, is intended to be embraced in the prevent invention.

For FIGS. 15 and 17, it is also possible to make a charge on a downloading operation of a data set from a picture database server and a speech segment database server.

Regarding a second, a fourth and a fifth preferred embodiment, it is further possible to store a speech segment data set and a frame data set that are downloaded by a receiving terminal while correlating the data sets with codes that discriminate a transmitter, and thereafter, to use the stored data sets in dealing with data from the same transmitter.

For any of a first embodiment through a sixth embodiment, a transmission between a transmission terminal and a distribution server, or between a distribution terminal and a receiving terminal can either be of a wired or a wireless transmission. Further, the transmission can be of a line switching or of a packet switching. In addition, in the first and the third embodiment, the transmission between the distribution server and a speech and video synthesis server can either be of a wired or a wireless transmission, or otherwise, the transmission can either be of a line switching or of a packet switching. Also, the distribution server and the speech and video synthesis server can be of a same device.

For any of a first embodiment through a fifth embodiment, shown was an example wherein a selection of a synthesized speech and a selection of a synthesized video image are executed independently (separately), but a selection of a speech and a video image in a set is intended to be embraced in the prevent invention. In this case, only one system is required for a selection signal between a distribution server and a speech and video synthesis server, and further a picture database server and a speech segment database server in FIGS. 15 and 17 can be integrated into one server.

In FIGS. 12 and 21, an encoded speech and an encoded video image are output after being multiplexed, but the encoded speech and the encoded video image may be output as two independent data without being multiplexed, wherein, by adding a decoding time information (including a time stamp and a frame number) to respective data, a speech and a video image can easily be synchronized at the time of decoding.

In FIGS. 13 and 14, used was an example wherein a face picture is selected and presented in accordance with the type of a speech segment and the duration, but a similar effect will be obtained in modifications described below. For the number of face pictures in FIG. 14, an example of seven types is shown, but much more number of pictures can be used, wherein a more natural or a more detailed facial expression can be presented, thus offering an effect of increased spontaneity.

A similar effect can be expected even when a speech segment and a face picture are not exactly correlated. For example, a similar effect can be obtained when a speech output section and a specific face picture is correlated, and a speech non-output section and a specific face picture is correlated. Specifically, quoted here is an example wherein, for the speech output section, a picture 0 and a picture 1 in FIG. 14 is alternatively selected at an appropriate interval. At this time, in the speech non-output section (Silence period), a natural feeling of blinking can be expected by presenting a face picture 0 and a face picture 6 at an appropriate interval as shown in FIG. 13. This example of a modification offers effects to achieve reductions for example, in a memory capacity of a picture memory, a transmission time of a frame data set, and in the size of a picture database server, since the number of face pictures requires only three types of face picture 0, 1 and 6 in FIG. 14.

The other modification in which a speech segment and a face picture are not correlated is a method wherein random pictures are presented in a speech output section, while a face picture 0 and a face picture 6 are presented at an appropriate interval for a speech non-output section (Silence period) as shown in FIG. 13. With this method, a frame data set can easily be created, since the method allows a sampling of a frame from an original picture sequence at a random or a certain interval, and the frame thus sampled can be used as a frame data set.

Processing in all preferred embodiments and modifications stated above can be either of a software processing, a hardware processing or a combined processing of software and hardware.

As described above, according to the present invention, it is possible to reduce the processing amount of a transmission terminal by synthesizing and encoding a speech and video information based on text information, thus miniaturizing the terminal and realizing to prolong the service life of a terminal battery.

What is claimed is:

1. A media distribution system having a server which distributes media information transmitted by a first terminal to a second terminal, said server comprising:
means for acquiring media decoding capability of said second terminal; and
means for converting said media information into media information to be output according to said media decoding capability acquired.

2. A multi-media conversion server comprising:
means for receiving media information transmitted by a first terminal;
means for acquiring a destination of said media information received;
means for acquiring media decoding capability of a second terminal which is said destination;
means for converting said media information into media information to be output according to said media decoding capability of said second terminal; and
means for transmitting said output media information to said second terminal.

3. A multi-media conversion server comprising:
means for receiving character information addressed to a second terminal by a first terminal;
speech signal conversion means for converting said character information into a speech signal;
video signal synthesis means for synthesizing a video signal corresponding to said speech signal;
speech synthesis means for encoding said speech signal in one of formats which allow said second terminal to receive and decode such signal;
video encoding means for encoding said video signal in one of formats which allow said second terminal to receive and decode such signal; and
means for adding the synthesized speech stream and the synthesized video stream to said character information, and sending such streams to said second terminal.

4. A multi-media conversion server of claim 3, further comprising means for acquiring format information that can be received and decoded by said second terminal, wherein said speech synthesis means and said video synthesis means are configured to perform synthesizing operations using said format information.

5. A multi-media conversion server of claim 3, further comprising means for presenting a plurality of speech types to be converted and a plurality of video types to be synthesized to said first terminal, and instructing to select and specify each one type from among the speech and video types;
wherein said speech synthesis means converts said speech encoding information and the video encoding information thus selected in the above into a speech signal according to the content of the selected speech selection information of a reception signal attached to character information, and wherein said video synthesis means synthesizes said video signal selected in the above.

6. A multi-media terminal wherein communication is executed between the multi-media terminal and a multi-media conversion server of claim 5, comprising:
means for entering and editing characters;
means for presenting said speech type to be converted, and synthesizing the speech selection information selected; and
a function for presenting said video type, and synthesizing the video selection information selected;
wherein the input character information and the synthesized speech selection information as well as the synthesized video selection information are transmitted.

7. A multi-media conversion server comprising:
means for receiving video information addressed to a second terminal from a first terminal;
means for acquiring video format information that can be received and decoded by said second terminal;
means for comparing a video format of said received video information with a video format that can be received and decoded by said second terminal;
if any corresponding video format which allows the second terminal to receive and decode the received video information is not available as a result of said comparison, means for selecting one video format that can be received and decoded by said second terminal, and converting said entered video information into that of the video format thus selected; and
means for transmitting said converted video information to said second terminal.

8. A multi-media conversion server comprising:
means for receiving video information addressed to a second terminal from a first terminal;
means for acquiring screen size information that can be received and decoded by said second terminal;
means for comparing the screen size of said received video information with screen size information that can be received and decoded by said second terminal;
if the screen size of the received video information is larger than the screen size that can be received and decoded by said second terminal as a result of the foregoing comparison, means for converting said entered video information into that of the screen size that can be received and decoded by said second terminal; and
means for transmitting the thus converted video information to said second terminal.

9. In a multi-media conversion server of claim 1, a multi-media conversion service characterized in that a conversion fee that is determined based on the combination of an input media information type with an output media in formation type is charged to a transmitter.

10. In a multi-media conversion server of claim 3, 4, 6 or 7, a multi-media communication service characterized in that, when a conversion is made from received character information to speech information or video information, a higher fee is charged to a transmitter compared to the case where no conversion is made.
